(19) United States
(12) Patent Application Publication
(10) Pub. No.: US 2019/0084355 A1
(43) Pub. Date: Mar. 21, 2019

(54) Driving Companion Tread-Life Indicator System

(71) Applicant: COMPAGNIE GENERALE DES ETABLISSEMENTS MICHELIN, CLERMONT-FERRAND (FR)

(72) Inventors: Erin McPillan, Simpsonville, SC (US); Vickie Johnson, Greenville, SC (US); Yves Faurisson, Garches (FR)

(21) Appl. No.: 16/083,020

(22) PCT Filed: Mar. 9, 2017
(86) PCT No.: PCT/US2017/021494

§ 371 Date: Sep. 7, 2018

Related U.S. Application Data
(60) Provisional application No. 62/305,798, filed on Mar. 9, 2016.

(51) Int. Cl. B60C 11/24; G06Q 10/00; B60C 25/00

(52) U.S. Cl. CPC B60C 11/246; B60C 25/007; G06Q 10/20

(57) ABSTRACT

The present disclosure provides a driving companion tread-life indicator system and methods of operation thereof. One example computer-implemented method includes receiving data associated with one or more tread depth measurements. The one or more tread depth measurements were made by a measurement device external to a vehicle. The one or more tread depth measurements are descriptive of a tread depth of at least one tread of at least one tire of the vehicle. The method includes associating a respective time value with each of the one or more tread depth measurements. The method includes accessing a model that correlates the one or more tread depth measurements to a projected tread depth. The method includes determining an estimated time at which the projected tread depth is expected to equal or pass a tread depth threshold based at least in part on the model. The method includes providing the estimated time to a notification system.

### PRIORITY CLAIM

The present application claims the benefit of priority of U.S. Provisional Patent Application Ser. No. 62/305,798, titled “Driving Companion Tread-Life Indicator System,” filed Mar. 9, 2016, which is incorporated herein by reference.

### FIELD

The present disclosure relates generally to tire tread-life monitoring, and more particularly, to a driving companion tread-life indicator system which employs a user computing device.

### BACKGROUND

Vehicle tires typically include treads which make contact with the road or ground. Treads can serve to displace water and assist with vehicle traction. A tread depth can refer to a vertical measurement from a top of the tread to a bottom of a corresponding tread groove.

As a tire is used over time, the tread on the tire can be worn away, causing the corresponding tread depth to reduce over time. If the tread depth becomes too small, the effectiveness of the tread in providing traction is reduced. Thus, tires typically have an end-of-life tread depth associated therewith. For example, 1.6 mm or 2/32 of an inch can generally be used as an end-of-life tread depth for typical automotive tires. When the tread depth of a tire reaches or falls below the end-of-life tread depth, it can be advisable to replace the tire to ensure safe operation of the vehicle.

However, many vehicle operators do not routinely check the tread depth of their tires. For example, the operator may not have the correct gauge or instrument to accurately measure the tread depth. As another example, the operator may simply not have the appropriate knowledge or desire to routinely check the tread depth of the tires, or may forget to do so for a significant period of time. As a result, a vehicle operator may operate the vehicle despite the tread depth of one or more of the tires being less than the end-of-life tread depth.

Furthermore, for the reasons discussed above, consumers are often required to purchase tires without adequate notice to prepare financially for such purchase. For example, a vehicle operator may not be aware of the need to replace the tires until the vehicle is inspected by an automotive expert or technician. Accordingly, tires are often bought as a distress purchase.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method for monitoring tire tread-life. The method includes receiving, by one or more processors, data associated with one or more tread depth measurements. The one or more tread depth measurements were made by a measurement device external to a vehicle. The one or more tread depth measurements are descriptive of a tread depth of at least one tread of at least one tire of the vehicle. The method includes associating, by the one or more processors, a respective time value or a distance value with each of the one or more tread depth measurements. The method includes accessing, by the one or more processors, a model that correlates the one or more tread depth measurements to a projected tread depth. The method includes determining, by the one or more processors, an estimated time or an estimated distance at which the projected tread depth is expected to equal or pass a tread depth threshold based at least in part on the model. The method includes providing, by the one or more computing devices, the estimated time or the estimated distance to a notification system integrated as part of a user computing device.

Another example aspect of the present disclosure is directed to a system for monitoring tire tread-life. The system includes one or more computing devices that include at least one processor and at least one non-transitory computer-readable medium that stores instructions that, when executed by the at least one processor, cause the one or more computing devices to receive data associated with one or more tread depth measurements. The one or more tread depth measurements were made by a measurement device external to a vehicle. The one or more tread depth measurements are descriptive of a tread depth of at least one tread of at least one tire of the vehicle. Execution of the instructions by the at least one processor further causes the one or more computing devices to: associate a respective time value with each of the one or more tread depth measurements; access a model that correlates the one or more tread depth measurements to a projected tread depth; determine an estimated time at which the projected tread depth is expected to equal or pass a tread depth threshold based at least in part on the model; and provide the estimated time to a notification system integrated as part of a user computing device.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system to monitor tire tread-life according to example embodiments of the present disclosure.

FIG. 2 depicts a block diagram of an example system to monitor tire tread-life according to example embodiments of the present disclosure.

FIG. 3 depicts a flow chart diagram of an example method to monitor tire tread-life according to example embodiments of the present disclosure.

FIG. 4 depicts a flow chart diagram of an example method to monitor tire tread-life according to example embodiments of the present disclosure.

FIG. 5 depicts a flow chart diagram of an example method to monitor tire tread-life according to example embodiments of the present disclosure.

FIG. 6 depicts a flow chart diagram of an example method to monitor tire tread-life according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the invention. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Example aspects of the present disclosure are directed to a driving companion tread-life indicator system. In particular, example aspects of the present disclosure provide systems and methods that can determine a projected tread depth of at least one tire of a vehicle based on one or more tread depth measurements for such tire. Next, the systems and methods of the present disclosure can determine an estimated time or an estimated distance at which the projected tread depth is expected to equal or pass a tread depth threshold. For example, the tread depth threshold can correspond to an end-of-life tread depth. The estimated time or estimated distance can be provided to a notification system integrated into a user computing device (e.g., smartphone or tablet) associated with the vehicle operator.

In some embodiments, the notification system can monitor a current time and can provide an alert to a device user when the current time reaches or approaches the estimated time. In addition and/or in the alternative, the notification system can monitor a current distance of the vehicle and can provide an alert to a device user when the current distance reaches or approaches the estimated distance. Thus, the present disclosure provides an advanced tread-life estimation and monitoring system, at least portions of which are integrated into a user computing device of the vehicle operator. The system proactively alerts a vehicle operator regarding the tread depth conditions of the vehicle, thereby ensuring that the vehicle is operated in a safe condition and also allowing the vehicle operator to financially plan for an upcoming tire purchase.

More particularly, a measurement device can collect one or more tread depth measurements for at least one tire of a vehicle. For example, the measurement device can be external to the vehicle. In some implementations, the tread depth measurements are collected at for two or more different vehicle distances or times.

As one example, the measurement device can be a drive-over measurement device. In some instances, the drive-over measurement device can optically measure the tread depth of the tire (e.g., using lasers, cameras, or other optical measurement techniques). In other instances, non-optical techniques such as RADAR can be used. As another example, the measurement device can be a manually operated measurement device such as a manually-operated gauge.

In some implementations of the present disclosure, a tread depth measurement can be collected for each of a plurality of tread grooves of each tire of the vehicle. For example, an example vehicle may have four tires, and each tire can have a number of tread grooves which each have a respective depth. A tread depth measurement can be collected for each of such tread grooves.

The collected measurements can be provided (e.g., transmitted over a network) to one or more computing devices for use in determining a projected tread depth. In particular, according to an aspect of the present disclosure, one or more computing devices can be configured to implement a tread-life estimator that calculates or otherwise determines at least one projected tread depth for a particular tire based on the tread depth measurements collected for such tire. Further, in some implementations, the tread-life estimator can determine a projected tread depth for each tread of the tire based on the respective measurements collected for such tread.

In some implementations, the one or more computing devices that implement the tread-life estimator correspond to one or more server computing devices which are accessible over a network (e.g., devices located “in the cloud”). In other implementations, the one or more computing devices that implement the tread-life estimator correspond to a user computing device (e.g., a smartphone or tablet) associated with the vehicle operator.

Regardless of the nature of the computing device, the tread-life estimator can receive data associated with the tread depth measurements. A respective time can be associated with each of the tread depth measurements. For example, the respective time associated with each tread depth measurement can be the time (e.g., date) at which such tread depth measurement was collected.

In some implementations, in addition or alternatively to a respective time, a respective distance can be associated with each tread depth measurement. For example, the current distance of the vehicle at the time when each measurement was collected can be associated with such measurement.

The tread-life estimator can determine a projected tread depth based on the received measurement data. In some implementations, the projected tread depth can be a projection of the tread depth versus time and/or versus vehicle distance.

As an example, in some implementations, the tread-life estimator can access and use a model that correlates the one or more tread depth measurements to the projected tread depth. For example, the model can include a look-up table, a function, an algorithm, or other model that receives the tread depth measurements as input and outputs the projected tread depth.

In some implementations, the tread-life estimator can determine the projected tread depth by performing a linear projection with respect to the tread depth measurements and their respective times. In other implementations, other forms of projection and/or curve fitting can be employed to determine the projected tread depth, such as by using a polynomial function, piecewise function, or other model correlating projected tread depth as a function of one or more variables including the tread depth measurements.

According to another aspect of the present disclosure, the tread-life estimator can determine an estimated time at which the projected tread depth is expected to equal or pass a tread depth threshold. For example, the estimated time can be an estimated date. As one example, the tread depth threshold can be an end-of-life threshold. As another example, the tread depth threshold can be a replacement warning threshold. For example, the replacement warning threshold can be equal to the end-of-life threshold multiplied by a number slightly greater than one. Use of a replacement warning threshold assists in providing the vehicle operator with sufficient notice to begin financially planning for purchase of replacement tires. In some implementations, multiple tread depth thresholds can be used to determine multiple respective estimated times for such thresholds.

According to another aspect of the present disclosure, alternatively or in addition to the estimated time, the tread-life estimator can also determine an estimated distance at which the projected tread depth is expected to equal or pass the tread depth threshold. Thus, the tread-life estimator can determine a time and/or distance at which the projected tread depth is expected to meet the tread depth threshold.

Further, in implementations in which a plurality of projected tread depths are determined respectively for a plurality of tread grooves of a tire, the tread-life estimator can determine an estimated time for each of such tread grooves. Alternatively, the tread-life estimator can determine a single estimated time at which a number of the projected tread depths are expected to equal or pass a respective tread depth threshold. The number can equal one, a majority, or other numbers. Thus, the estimated time can correspond to an earliest estimated time at which any of the projected tread depths are expected to equal or pass the threshold.

The tread-life estimator can provide the estimated time to a notification system. In some implementations, the notification system can be integrated into the user computing device. The notification system can monitor the current time and can provide an alert to the device user when the current time reaches or approaches the estimated estimate. For example, the notification system can display an alert on a screen of the user computing device.

Likewise, in addition or alternatively to time, in some implementations, the notification system can monitor a current distance of the vehicle and can provide an alert to the device user when the current distance reaches or approaches an estimated distance at which the projected tread depth is expected to equal or pass the tread depth threshold.

Thus, the present disclosure provides systems and methods that can project the tread depth of at least one tire based on one or more collected tread depth measurements; determine an estimated time and/or distance at which the projected tread depth is expected to reach or exceed a tread depth threshold; and then monitor the vehicle time and/or distance so as to provide an alert when the estimated time and/or distance is reached.

As such, the systems and methods of the present disclosure provide an alert that notifies the driver that it is advisable (or almost advisable) to replace at least one of the tires. Proactive notification in this manner reduces the amount of drivers that fail to recognize that one or more of their tires has an undesirably low tread depth.

Therefore, one benefit provided by the systems and methods of the present disclosure is increased automotive safety through reduced use of vehicles with undesirably low tread depths. A technical benefit achieved by the present disclosure is the automatic projection and monitoring of tire tread depth.

According to another aspect of the present disclosure, in some implementations, additional sensor data can be collected from sensors included in the vehicle and/or included in the user computing device. The additional sensor data can be used to revise, adjust, and/or determine the projected tread depth.

More particularly, in some implementations, the vehicle can include a number of sensors that collect data about various conditions associated with the vehicle. As examples, the sensors can respectively provide lateral acceleration data; longitudinal acceleration data; speed data; weather data; geographic location data; steer angle data; vehicle yaw, pitch, and roll data; and/or tire inflation pressure data.

Furthermore, in some implementations, the user computing device can include one or more sensors which provide data that is similar to those listed above. For example, a user computing device can include sensors which respectively provide lateral acceleration data; longitudinal acceleration data; speed data; geographic location data; and device yaw, pitch, and roll data. When the user computing device is co-located with the vehicle, the sensor data provided by the user computing device sensors can be used in addition or alternatively to the sensor data from the vehicle. Thus, in some implementations in which vehicle sensor data is not available, user computing device sensor data can be used to approximate vehicle conditions and can be used to revise, adjust, and/or determine the projected tread depth.

In one example, the sensor data received from the vehicle and/or user computing device sensors can be provided to the tread-life estimator. As noted above, in various implementations, the tread-life estimator can be implemented by one or more server computing devices or by the user computing device.

The tread-life estimator can employ one or more models to revise, adjust, and/or determine the projected tread depth based on the received sensor data. For example, the model(s) can take the sensor data and the tread depth measurements as input and output a new projected tread depth. Similarly, the tread-life estimator can also use the model(s) to revise the projected tread depth based on newly received sensor data and/or tread depth measurements.

In another example, the tread-life estimator and/or the notification system can analyze the sensor data received from the vehicle and/or user computing device sensors and can detect an abnormal change in the sensor data. In response to detection of an abnormal change in the sensor data, the tread-life estimator can adjust the projected tread depth, the estimated time, and/or the estimated distance (e.g., through use of model(s) as described above). As another example, in response to detection of the abnormal change in the sensor data, the notification system can provide an alert to the device user.

According to another aspect, the systems and methods of the present disclosure can use the projected tread depth described above to determine an amount of wear that is expected to occur over a given period of time, such as, for example, a month. As examples, the amount of wear can be characterized by reduction in magnitude of tread depth (e.g., loss of 0.1 mm) or as used percentage of tread-life (e.g., 5% used) over such time period.

The ability to project an amount of wear over a period of time can be utilized to enable wear-based payment for tires. For example, tires can be sold on a monthly payment plan, where the magnitude of the monthly payment corresponds to the amount of wear projected or used for such month. The payments can be used to pay for the currently used tires or as an investment in a new set of tires when the current tires need replacing.

Thus, by using data to project the wear out of tires and the wear severity related to driving behavior, a monthly tire usage plan can be offered. For example, if tires are wearing quicker than the plan that was purchased, the purchaser can be charged for the extra wear, or if wear severity is low due to controlled driving behavior, a cheaper plan can be offered. Through notification and observation of their monthly tire usage payment, drivers can be taught to minimize their wear and, therefore, minimize their monthly payment.

As another benefit, the ability to accurately project tire wear according to the techniques described above enables prediction of what tire needs to be produced when, and where to distribute the tire in order to have it available when the predicted tire change occurs. Thus, not only do the systems and methods of the present disclosure enable proactive notification of the driver regarding expected tire replacement requirements, but, in some implementations, a manufacturer of tires can also receive such proactive notification and can adjust their operations accordingly.

With reference now to the Figures, example embodiments of the present disclosure will now be discussed in detail.

### Example Systems

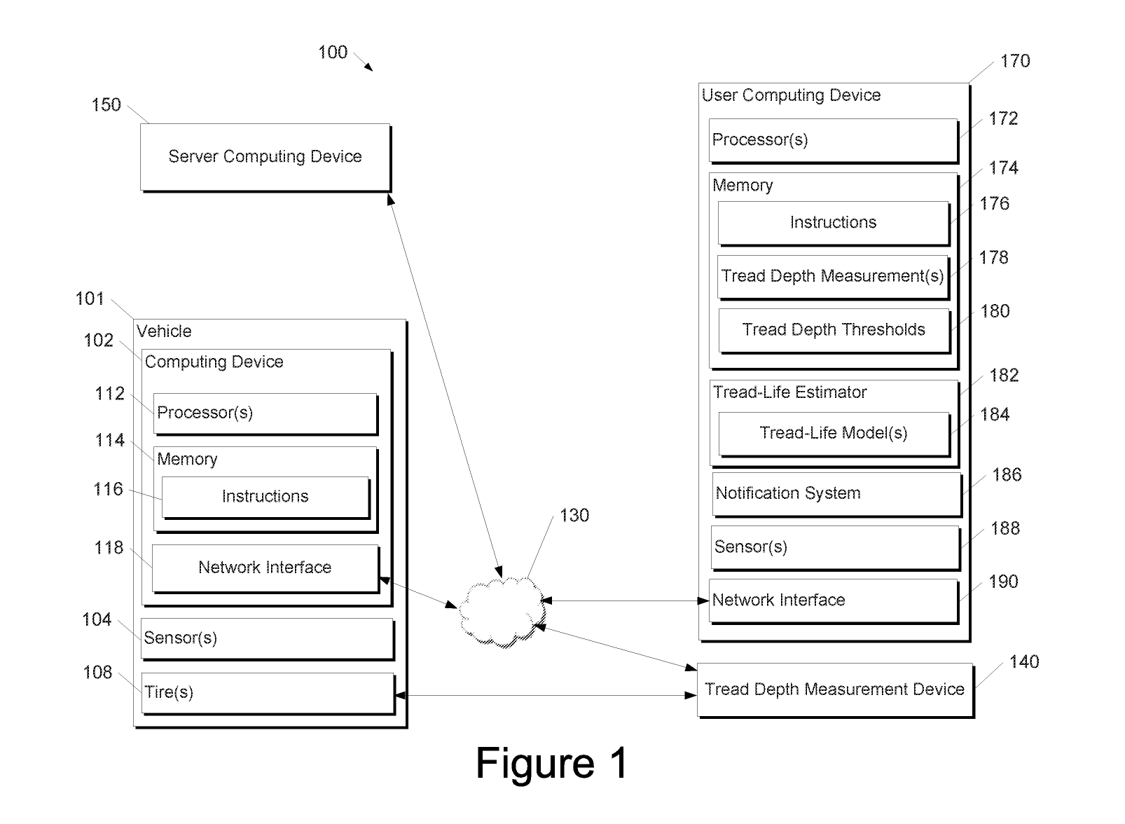

FIG. 1 depicts a block diagram of an example system 100 to monitor tire tread-life according to example embodiments of the present disclosure. In particular, the system 100 includes a tread-life estimator 182 implemented by a user computing device 170.

More particularly, the system 100 includes a vehicle 101. The vehicle 101 can be any vehicle that includes one or more tires 108. For example, the vehicle 101 can be a car, truck, motorcycle, bicycle, airplane, self-balancing personal transportation vehicle, or other vehicle.

The vehicle 101 includes the computing device 102. The computing device 102 includes one or more processors 112 and a memory 114. The one or more processors 112 can be any form of processing device, including, for example, a processing unit, a microprocessor, a controller, a microcontroller, an application specific integrated circuit, etc. The memory 114 can include one or more of any non-transitory computer-readable medium, including, for example, RAM (e.g., DRAM), ROM (e.g., EEPROM), optical storage, magnetic storage, flash storage, solid-state storage, hard drives, or some combination thereof. The memory 114 can store one or more sets of instructions 116 that, when executed by the computing device 102, cause the computing device 102 to perform operations consistent with the present disclosure.

The computing device 102 can further include a network interface 124 to enable communication over a network 130 with a server computing device 150 and/or the user computing device 170. The network interface 124 can include any number of components to provide networked communications (e.g., transceivers, antennas, controllers, cards, etc.). In some implementations, the vehicle 101 does not include a computing device 102 that is operable to communicate over the network 130.

The user computing device 170 can be a personal computing device associated with the operator and/or owner of the vehicle 101. For example, the user computing device 170 can be a mobile user computing device such as a smartphone, a tablet computing device, a laptop computer, or a wearable computing device. However, in some implementations, the user computing device 170 can also be an immobile computing device.

Similar to computing device 102, the user computing device 170 can include one or more processors 172 and a memory 174. The one or more processors 172 can be any form of processing device, including, for example, a processing unit, a microprocessor, a controller, a microcontroller, an application specific integrated circuit, etc. The memory 174 can include one or more of any non-transitory computer-readable medium, including, for example, RAM (e.g., DRAM), ROM (e.g., EEPROM), optical storage, magnetic storage, flash storage, solid-state storage, hard drives, or some combination thereof. The memory 174 can store one or more sets of instructions 176 that, when executed by the user computing device 170, cause the user computing device 170 to perform operations consistent with the present disclosure.

The user computing device 170 can further include a network interface 190 to enable communication over the network 130 with the vehicle 101, the server computing device 150, and/or a tread depth measurement device 140. The network interface 190 can include any number of components to provide networked communications (e.g., transceivers, antennas, controllers, cards, etc.).

According to an aspect of the present disclosure, the memory 174 can store or include one or more tread depth measurements 178. In particular, the user computing device 170 can receive the tread depth measurements 178 from the tread depth measurement device 140 and can store the measurements 178 in the memory 174.

In some implementations, the measurement device 140 can be external to the vehicle 101. As one example, the measurement device 140 can be a drive-over measurement device 140. In some instances, the drive-over measurement device 140 can optically measure the tread depth of the tires 108 (e.g., using lasers, cameras, or other optical measurement techniques). In other instances, non-optical techniques such as RADAR can be used. As another example, the measurement device 140 can be a manually operated measurement device such as a manually-operated gauge.

In one example scenario, the measurement device 140 can be placed in a location where many cars frequently pass, such as, for example, a waiting line or a filling station at a gas station. While the vehicle 101 is positioned over the measurement device 140, the device 140 can collect one or more measurements of the tread depth of the tires 108 of the vehicle 101.

In some implementations of the present disclosure, the measurement device 140 can collect a tread depth measurement 178 for each of a plurality of tread grooves of each tire 108 of the vehicle. For example, an example vehicle 101 may have four tires 108, and each tire 108 can have a number of tread grooves which each have a respective depth. A tread depth measurement 178 can be collected for each of such tread grooves. Tread depth measurements 178 can be collected on a single occasion or on multiple occasions.

The measurement device 140 can provide the collected measurements 178 to user computing device 170 for use in determining a projected tread depth. As an example, in some implementations, the measurement device 140 can transmit the tread depth measurements 178 directly to the user computing device 170. For example, the measurement device 140 can connect to the user computing device 170 over a local area network such as a Bluetooth network or other short range wireless network.

In other implementations, the measurement device 140 can upload the tread depth measurements 178 to the server computing device 150 over a wide area network. The server computing device 150 can then provide the tread depth measurements 178 to the user computing device 170 over the wide area network. In yet other implementations, the tread depth measurements 170 can be manually entered into the user computing device 170, for example, through use of a user interface of the user computing device 170.

The memory 174 can further store or include one or more tread depth thresholds 180. In some implementations, a single tread depth threshold 180 can be used for all of the tires 108. In other implementations, different tread depth thresholds 180 can be used for different tires 108 and/or different tread grooves on a single tire 108. For example, different tread depth thresholds 180 can be used depending on the location of the tire (e.g., rear-right versus front-left) or depending on the location of the tread (e.g., outer tread versus central tread). As another example, different tread depth thresholds can be used depending on the style of the tire 108 (e.g., snow versus all-weather) and/or the make of the vehicle 101 (e.g., truck versus sports sedan). In some implementations, a user can select or set a number of tread depth thresholds in addition to one or more pre-programmed tread depth thresholds 180.

As one particular example, the tread depth thresholds 180 can include an end-of-life threshold. For example, 1.6 mm or 2/32 of an inch can generally be used as an end-of-life tread depth threshold for typical automotive tires 108. However, other values can be used instead. As another example, the tread depth thresholds 180 can include a replacement warning threshold. For example, the replacement warning threshold can be equal to the end-of-life threshold multiplied by a number slightly greater than one. Use of a replacement warning threshold assists in providing the vehicle operator with sufficient notice to begin financially planning for purchase of replacement tires. In some implementations, multiple tread depth thresholds 180 can be used to determine multiple respective estimated times for such thresholds. For example, both a replacement warning threshold and an end-of-life threshold can be used to provide to result in a notification system 186 providing two separate alerts to the vehicle operator.

According to an aspect of the present disclosure, the user computing device 170 can also include and implement a tread-life estimator 182. The user computing device 170 can implement the tread-life estimator 182 to calculate or otherwise determine at least one projected tread depth for a tire 108 based on the tread depth measurements 178 collected for such tire 108. Further, in some implementations, the tread-life estimator 182 can be implemented to determine a projected tread depth for each tread of the tire 108 based on the respective measurements collected for such tread.

The tread-life estimator 182 includes computer logic utilized to provide desired functionality. The tread-life estimator 182 can be implemented in hardware, firmware, and/or software controlling a general purpose processor. For example, in some implementations, the tread-life estimator 182 includes program files stored on a storage device, loaded into a memory and executed by one or more processors. In other implementations, the tread-life estimator 182 includes one or more sets of computer-executable instructions that are stored in a tangible computer-readable storage medium such as RAM hard disk or optical or magnetic media.

More particularly, the tread-life estimator 182 can receive data associated with the tread depth measurements 178. A respective time can be associated with each of the tread depth measurements 178. For example, the respective time associated with each tread depth measurement can be the time (e.g., date) at which such tread depth measurement was collected.

In some implementations, in addition or alternatively to a respective time, a respective distance can be associated with each tread depth measurement 178. For example, the current distance of the vehicle 101 at the time at which each measurement 178 was collected can be associated with such measurement 178.

The tread-life estimator 182 can determine a projected tread depth based on the received measurement data. In some implementations, the projected tread depth can be a projection of the tread depth versus time and/or versus vehicle distance.

As an example, in some implementations, the tread-life estimator 182 can access and use a tread-life model 184 that correlates the one or more tread depth measurements 178 to the projected tread depth. For example, the model 184 can include a look-up table, a function, an algorithm, or other model that receives the tread depth measurements 178 as input and outputs the projected tread depth. In some implementations, the model 184 can consider or otherwise receive as input tire-specific characteristics such as tread design, material composition, size, historical performance data, rotation history, or other tire characteristics.

In some implementations, the tread-life estimator 182 can determine the projected tread depth by performing a linear projection with respect to two or more tread depth measurements 178 collected at two or more different times and/or distances. In other implementations, other forms of projection and/or curve fitting can be employed to determine the projected tread depth. For instance, a polynomial model can be used to determine the projected tread depth. As another example, a piece-wise function can be used to determine the projected tread depth. A variety of models that take into account a plurality of different variable can be used without deviating from the scope of the present disclosure.

In some implementations, the tread-life estimator 182 can determine the projected tread depth based on one or more tread depth measurements 178 collected at a single time and/or distance. For example, the single set of tread depth measurements 178 can serve as a calibration measurement or starting measurement. Thereafter, the tread-life estimator 182 can use additional data other than newly collected tread depth measurements 178 to determine and/or revise the projected tread depth. For example, as will be discussed further below, the tread-life estimator 182 can use sensor data collected or received from one or more sensors 104 of the vehicle 101 and/or one or more sensors 188 of the user computing device 170 to assist in determining and/or adjusting the projected tread depth.

According to another aspect of the present disclosure, the tread-life estimator 182 can determine an estimated time at which the projected tread depth is expected to equal or pass one of the tread depth thresholds 118. Alternatively or in addition to the estimated time, the tread-life estimator 182 can also determine an estimated distance at which the projected tread depth is expected to equal or pass the tread depth threshold 118. Thus, the tread-life estimator 182 can determine a time and/or distance at which the projected tread depth is expected to meet the tread depth threshold 180.

Further, in implementations in which a plurality of projected tread depths are determined respectively for a plurality of tread grooves of a tire 108, the tread-life estimator 182 can determine an estimated time for each of such tread grooves. Alternatively, the tread-life estimator 182 can determine a single estimated time at which a number of the projected tread depths are expected to equal or pass a respective tread depth threshold. The number of projected tread depths can equal one tread groove, a majority of the tread grooves, or other numbers.

The tread-life estimator 182 can provide the estimated time to a notification system 186 of the user computing device 170. The notification system 186 can monitor the current time and can provide an alert to the device user when the current time reaches or approaches the estimated time. For example, the notification system 186 can cause an alert or notification to be provided on a display of the user computing device 170. In some implementations, notification system 186 can include computer-readable instructions stored in memory 174 and executed by the one or more processors 172.

According to another aspect of the present disclosure, in some implementations, additional sensor data can be collected from sensors 104 included in the vehicle 101 and/or one or more sensors 188 included in the user computing device 170. The additional sensor data can be used to revise, adjust, and/or determine the projected tread depth.

More particularly, in some implementations, the vehicle 101 can include a number of sensors 104 that collect data about various conditions associated with the vehicle 101. As examples, the sensors 104 can respectively provide lateral acceleration data; longitudinal acceleration data; vertical acceleration data; speed data; weather data (e.g., temperature, wiper on duration as a precipitation indicator); geographic location data (e.g., from a GPS unit); steer angle data (e.g., steering wheel angle, steer ratio); vehicle yaw, pitch, and roll data; corner load data; ABS activations data; and/or tire inflation pressure data. Other data can also be collected regarding the tires 108 and/or the vehicle 101, such as, for example, TPMS ID (e.g., to detect rotations and snow tire placements); tire ID; consumer data; VIN; or any other relevant information.

Furthermore, in some implementations, the user computing device 170 can include one or more sensors 188 which provide data that is similar to those listed above. For example, the user computing device 170 can include sensors which respectively provide lateral acceleration data; longitudinal acceleration data; speed data; geographic location data; and device yaw, pitch, and roll data. When the user computing device 170 is co-located with the vehicle 101, the sensor data provided by the user computing device sensors 188 can be used in addition or alternatively to the sensor data from the vehicle 101. Thus, in some implementations in which vehicle sensor data is not available, user computing device sensor data can be used to approximate vehicle conditions and can be used to revise, adjust, and/or determine the projected tread depth.

In one example, the sensor data received from the sensors 104 or sensors 188 can be provided to the tread-life estimator 182. The tread-life estimator 182 can employ the one or more models 184 to revise, adjust, and/or determine the projected tread depth based on the received sensor data. For example, the model(s) 184 can take the sensor data and the tread depth measurements 178 as input and output a new projected tread depth. Similarly, the tread-life estimator 182 can also use the model(s) 184 to revise the projected tread depth based on newly received sensor data and/or tread depth measurements.

In another example, the tread-life estimator 182 and/or the notification system 186 can analyze the sensor data received from the vehicle sensors 104 and/or the device sensors 188 and can detect an abnormal change in the sensor data. In response to detection of an abnormal change in the sensor data, the tread-life estimator 182 can adjust the projected tread depth, the estimated time, and/or the estimated distance (e.g., through use of model(s) 184 as described above). As another example, in response to detection of the abnormal change in the sensor data, the notification system 186 can provide an alert to the vehicle operator.

The network 130 can be any type of communications network, such as a local area network (e.g., intranet), wide area network (e.g., Internet), or some combination thereof and can include any number of wired or wireless links. In general, communication between the server computing device 150 and the computing device 102 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL). Server computing device 150 can communicate with the computing device 102 over network 130 by sending and receiving data.

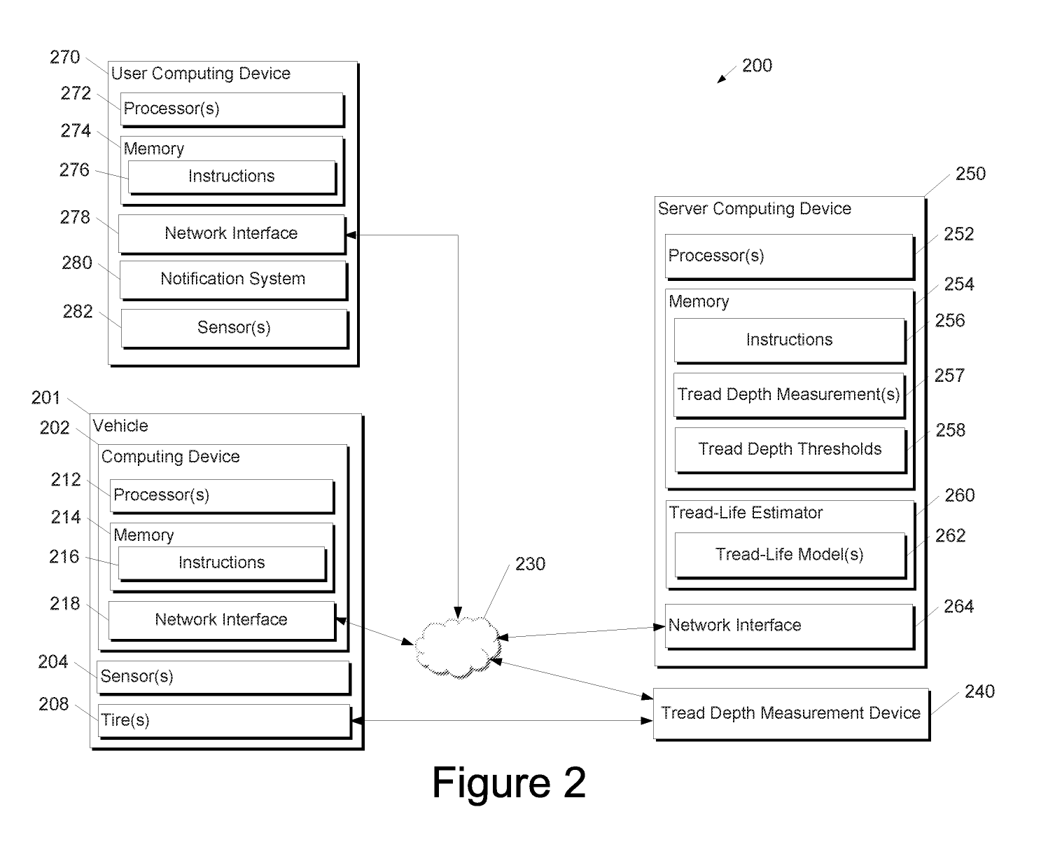

FIG. 2 depicts a block diagram of another example system 200 to monitor tire tread-life according to example embodiments of the present disclosure. In particular, the system 200 includes a tread-life estimator 260 implemented by a server computing device 250.

More particularly, the system 200 includes a vehicle 201. The vehicle 201 can be any vehicle that includes one or more tires 208. For example, the vehicle 201 can be a car, truck, motorcycle, bicycle, airplane, self-balancing personal transportation vehicle, or other vehicle.

The vehicle 201 can include a computing device 202. The computing device 202 includes one or more processors 212 and a memory 214. The one or more processors 212 can be any form of processing device, including, for example, a processing unit, a microprocessor, a controller, a microcontroller, an application specific integrated circuit, etc. The memory 214 can include one or more of any non-transitory computer-readable medium, including, for example, RAM (e.g., DRAM), ROM (e.g., EEPROM), optical storage, magnetic storage, flash storage, solid-state storage, hard drives, or some combination thereof. The memory 214 can store one or more sets of instructions 216 that, when executed by the computing device 202, cause the computing device 202 to perform operations consistent with the present disclosure.

The computing device 202 can further include a network interface 218 to enable communication over a network 230 with the server computing device 250 and/or a user computing device 270. The network interface 218 can include any number of components to provide networked communications (e.g., transceivers, antennas, controllers, cards, etc.).

The server computing device 250 can be one server device or can be multiple server computing devices that are operatively connected. Multiple devices can operate sequentially or in parallel. Similar to computing device 202, the server computing device 250 can include one or more processors 252 and a memory 254. The one or more processors 252 can be any form of processing device, including, for example, a processing unit, a microprocessor, a controller, a microcontroller, an application specific integrated circuit, etc. The memory 254 can include one or more of any non-transitory computer-readable medium, including, for example, RAM (e.g., DRAM), ROM (e.g., EEPROM), optical storage, magnetic storage, flash storage, solid-state storage, hard drives, or some combination thereof. The memory 254 can store one or more sets of instructions 256 that, when executed by the server computing device 250, cause the server computing device 250 to perform operations consistent with the present disclosure.

The server computing device 250 can further include a network interface 264 to enable communication over the network 230 with the vehicle 201, a tread depth measurement device 240, and/or the user computing device 270. The network interface 264 can include any number of components to provide networked communications (e.g., transceivers, antennas, controllers, cards, etc.).

According to an aspect of the present disclosure, the memory 254 can store or include one or more tread depth measurements 257. In particular, the server computing device 250 can receive the tread depth measurements 257 from the tread depth measurement device 240 and can store the measurements 257 in the memory 254. The measurement device 240 can be the same as or similar to the measurement device 140 described with reference to FIG. 1.

The measurement device 240 can provide the collected measurements 257 to the server computing device 250 for use in determining a projected tread depth. For example, the measurement device 240 can upload the tread depth measurements 257 to the server computing device 250 over the network 230 (e.g., a wide area network).

The memory 254 can further store or include one or more tread depth thresholds 258. The tread depth thresholds 258 can be the same as or similar to the tread depth thresholds 118 described with reference to FIG. 1.

According to an aspect of the present disclosure, the server computing device 250 can also include and implement a tread-life estimator 260. The tread-life estimator 260 can be the same as or similar to the tread-life estimator 182 described with reference to FIG. 1.

In particular, the server computing device 250 can implement the tread-life estimator 260 to calculate or otherwise determine at least one projected tread depth for a tire 208 based on the tread depth measurements 257 collected for such tire 208. Further, in some implementations, the tread-life estimator 260 can be implemented to determine a projected tread depth for each tread of the tire 208 based on the respective measurements collected for such tread.

More particularly, the tread-life estimator 260 can receive data associated with the tread depth measurements 257. A respective time can be associated with each of the tread depth measurements 257. For example, the respective time associated with each tread depth measurement can be the time (e.g., date) at which such tread depth measurement was collected.

In some implementations, in addition or alternatively to a respective time, a respective distance can be associated with each tread depth measurement 257. For example, the current distance of the vehicle 201 at the time at which each measurement 257 was collected can be associated with such measurement 257.

The tread-life estimator 260 can determine a projected tread depth based on the received measurement data. In some implementations, the projected tread depth can be a projection of the tread depth versus time and/or versus vehicle distance.

As an example, in some implementations, the tread-life estimator 260 can access and use a tread-life model 262 that correlates the one or more tread depth measurements 257 to the projected tread depth. For example, the model 262 can be the same as or similar to the model 184 described with reference to FIG. 1.

According to another aspect of the present disclosure, the tread-life estimator 260 can determine an estimated time at which the projected tread depth is expected to equal or pass one of the tread depth thresholds 258. Alternatively or in addition to the estimated time, the tread-life estimator 260 can also determine an estimated distance at which the projected tread depth is expected to equal or pass the tread depth threshold 258.

Further, in implementations in which a plurality of projected tread depths are determined respectively for a plurality of tread grooves of a tire 208, the tread-life estimator 260 can determine an estimated time for each of such tread grooves. Alternatively, the tread-life estimator 260 can determine a single estimated time at which a number of the projected tread depths are expected to equal or pass a respective tread depth threshold. The number of projected tread depths for tread grooves can equal one tread groove, a majority of the tread grooves, or other numbers.

The tread-life estimator 260 can provide the estimated time to a notification system 280 of the user computing device 270. For example, the server computing device 250 can transmit the estimated time and/or estimated distance to the user computing device 270 over the network 230.

The user computing device 270 includes one or more processors 272 and a memory 274. The one or more processors 272 can be any form of processing device, including, for example, a processing unit, a microprocessor, a controller, a microcontroller, an application specific integrated circuit, etc. The memory 274 can include one or more of any non-transitory computer-readable medium, including, for example, RAM (e.g., DRAM), ROM (e.g., EEPROM), optical storage, magnetic storage, flash storage, solid-state storage, hard drives, or some combination thereof. The memory 274 can store one or more sets of instructions 276 that, when executed by the computing device 202, cause the computing device 202 to perform operations consistent with the present disclosure. The user computing device 270 can further include a network interface 280 that enables communications over the network 230.

The user computing device 270 further includes the notification system 280. The notification system 280 can monitor a current time and can provide an alert to a device user when the current time reaches or approaches the estimated time. For example, the notification system 280 can be the same as or similar to the notification system 186 discussed with reference to FIG. 1.

According to another aspect of the present disclosure, in some implementations, additional sensor data can be collected from sensors 204 included in the vehicle 201. The additional sensor data can be used to revise, adjust, and/or determine the projected tread depth. Likewise, in some implementations, in addition or alternatively to data from sensors 204, additional sensor data can be collected from sensors 282 included in the user computing device 270.

More particularly, in some implementations, the vehicle 201 can include a number of sensors 204 that collect data about various conditions associated with the vehicle 201. As examples, the sensors 204 can be the same as or similar to the sensors 104 discussed with reference to FIG. 1. Likewise, the sensors 282 can be the same as or similar to the sensors 188 discussed with reference to FIG. 1.

In one example, the vehicle 201 can transmit the sensor data received from the sensors 204 over network 230 to the tread-life estimator 260. The tread-life estimator 260 can employ the one or more models 262 to revise, adjust, and/or determine the projected tread depth based on the received sensor data. For example, the model(s) 262 can take the sensor data and the tread depth measurements 257 as input and output a new projected tread depth. Similarly, the tread-life estimator 260 can also use the model(s) 262 to revise the projected tread depth based on newly received sensor data and/or tread depth measurements.

Similarly, the user computing device 270 can transmit the sensor data received from the sensors 282 over network 230 to the tread-life estimator 260. The tread-life estimator 260 can employ the one or more models 262 to revise, adjust, and/or determine the projected tread depth based on the received sensor data.

In another example, the tread-life estimator 260 and/or the notification system 280 can analyze the sensor data received from the vehicle sensors 204 and/or device sensors 282 and can detect an abnormal change in the sensor data. In response to detection of an abnormal change in the sensor data, the tread-life estimator 260 can adjust the projected tread depth, the estimated time, and/or the estimated distance (e.g., through use of model(s) 262 as described above). As another example, in response to detection of the abnormal change in the sensor data, the notification system 280 can provide an alert to the device user.

The network 230 can be any type of communications network, such as a local area network (e.g., intranet), wide area network (e.g., Internet), or some combination thereof and can include any number of wired or wireless links. In general, communication between the server computing device 250 and the user computing device 270 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL). Server computing device 250 can communicate with the user computing device 270 over network 230 by sending and receiving data.

### Example Methods

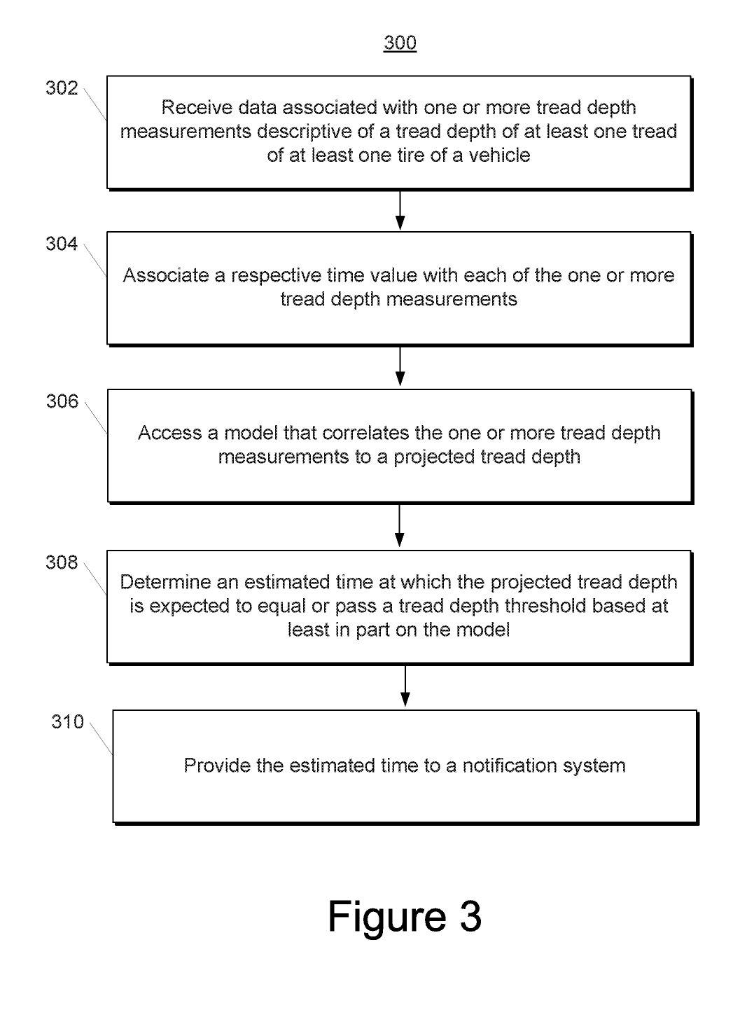

FIG. 3 depicts a flow chart diagram of an example method 300 to monitor tire tread-life according to example embodiments of the present disclosure. Method 300 can be implemented by one or more computing devices. In particular, as examples, method 300 can be implemented by the tread-life estimator 182 discussed with reference to FIG. 1 and/or the tread-life estimator 260 discussed with reference to FIG. 2.

At 302, one or more computing devices receive data associated with one or more tread depth measurements descriptive of a tread depth of at least one tread of at least one tire of a vehicle. The one or more tread depth measurements can have been made by a measurement device external to a vehicle.

At 304, the one or more computing devices associate a respective time value with each of the one or more tread depth measurements. For example, the distance value for each tread depth measurement can correspond to a current time at which such measurement was collected.

At 306, the one or more computing devices access a model that correlates the one or more tread depth measurements to a projected tread depth. For example, the model can include one or more look-up tables, formulas, and/or algorithms.

At 308, the one or more computing devices determine an estimated time at which the projected tread depth is expected to equal or pass a tread depth threshold based at least in part on the model.

In some implementations, to determine the estimated time at 308, the one or more computing devices can determine a linear projection for the projected tread depth based at least in part on one or more tread depth measurements and their respective time values; and identify the estimated time based at least in part on the linear projection and based at least in part on the tread depth threshold. Other more complex models can be used without deviating from the scope of the present disclosure, such as polynomial based models, piece-wise functions, etc.

At 310, the one or more computing devices provide the estimated time to a notification system. The notification system can use the estimated time to monitor the tread-life of the tire.

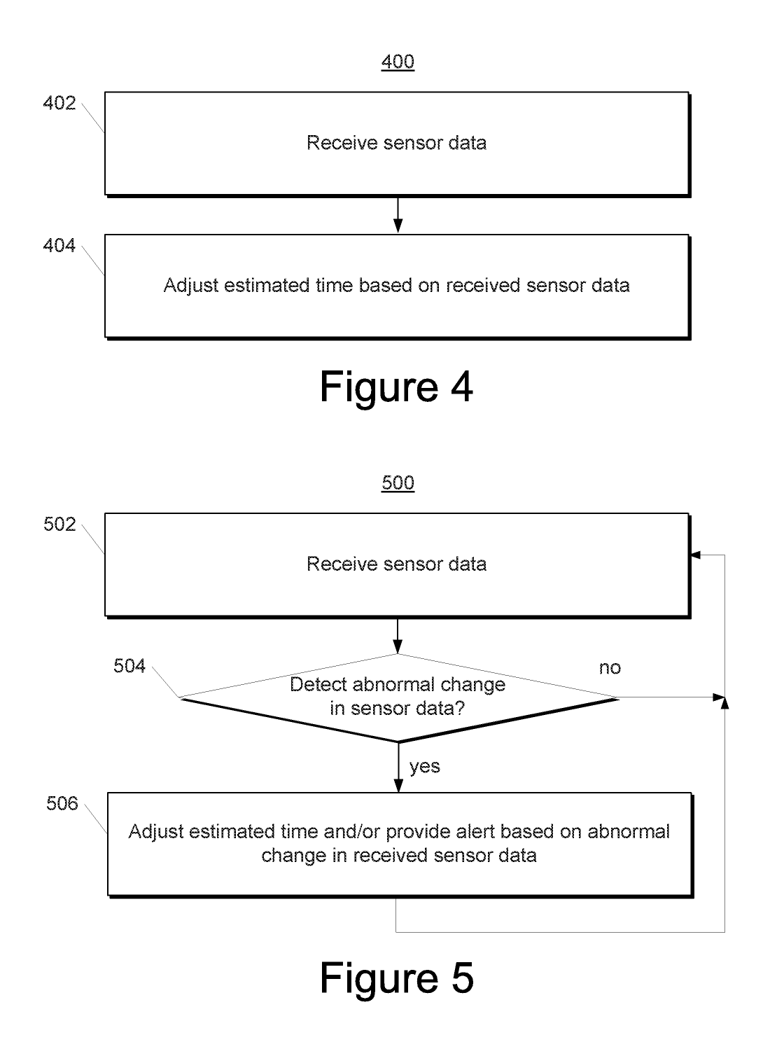

FIG. 4 depicts a flow chart diagram of an example method 400 to monitor tire tread-life according to example embodiments of the present disclosure. Method 400 can be implemented by one or more computing devices. In particular, as examples, method 400 can be implemented by the tread-life estimator 182 discussed with reference to FIG. 1 and/or the tread-life estimator 260 discussed with reference to FIG. 2.

At 402, the one or more computing devices receive sensor data. For example, the sensor data can include at least one of: lateral acceleration data; longitudinal acceleration data; speed data; weather data; geographic location data; steer angle data; vehicle yaw, pitch, and roll data; and tire inflation pressure data.

At 404, the one or more computing devices adjust an estimated time based on the received sensor data. For example, the received sensor data can be supplied to a tread-life model that adjusts the estimated time based on the sensor data.

FIG. 5 depicts a flow chart diagram of an example method 500 to monitor tire tread-life according to example embodiments of the present disclosure. Method 500 can be implemented by one or more computing devices. In particular, as examples, method 500 can be implemented by the tread-life estimator 182 and/or the notification system 186 discussed with reference to FIG. 1. As further examples, method 500 can be implemented by the tread-life estimator 260 and/or the notification system 280 discussed with reference to FIG. 2.

At 502, the one or more computing devices receive sensor data. For example, the sensor data can include at least one of: lateral acceleration data; longitudinal acceleration data; speed data; weather data; geographic location data; steer angle data; vehicle yaw, pitch, and roll data; and tire inflation pressure data.

At 504, the one or more computing devices determine whether an abnormal change in the sensor data has been detected. For example, running averages, global averages, or other statistical measures can be used to detect abnormal changes.

If it is determined at 504 that an abnormal change in the sensor data has not been detected, then method 500 returns to 502 and continues to receive sensor data. However, if it is determined at 504 that an abnormal change in the sensor data has been detected, then method 500 proceeds to 506.

At 506, the one or more computing devices adjust an estimated time and/or provide an alert based on the abnormal change in the sensor data. For example, a tread-life estimator can use a tread-life model adjust the estimated time based on the abnormal change in the sensor data. As another example, a notification system can provide an alert based on the abnormal change in the sensor data.

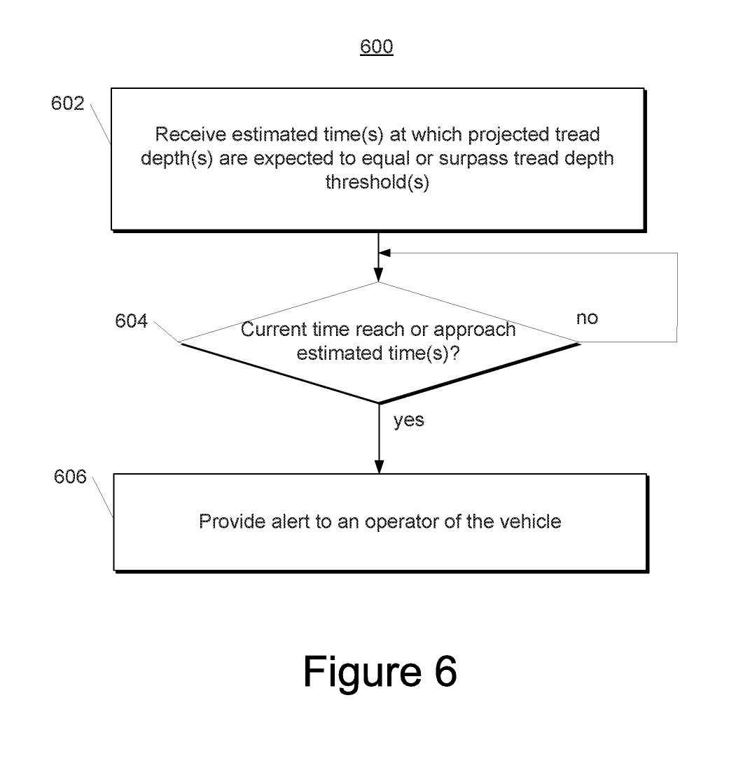

FIG. 6 depicts a flow chart diagram of an example method 600 to monitor tire tread-life according to example embodiments of the present disclosure. As examples, method 600 can be implemented by the notification system 186 discussed with reference to FIG. 1 and/or the notification system 280 discussed with reference to FIG. 2

At 602, a notification system receives one or more estimated times at which one or more projected tread depths are expected to equal or surpass one or more tread depth thresholds. For example, the one or more estimated times can be received from a tread-life estimator.

At 604, the notification system determines whether a current time of the vehicle is reaching or approaching one of the estimated time(s). If it is determined at 604 that the current distance of the vehicle is not reaching or approaching one of the estimated time(s), then method 600 returns to 604. In such fashion, method 600 monitors the current time relative to the estimated time(s).

However, if it is determined at 604 that the current distance of the vehicle is reaching or approaching one of the estimated time(s), then method 600 proceeds to 606. At 606, the notification system provides an alert to a device user. In some implementations, after 606, the method 600 returns to 602 or 604.

### ADDITIONAL DISCLOSURE

The technology discussed herein makes reference to servers, databases, software applications, and other computer-based systems, as well as actions taken by and information sent to and from such systems. The inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to various specific example embodiments thereof, each example embodiment is provided by way of explanation, not limitation of the disclosure. Those skilled in the art, upon attaining an understanding of the foregoing, may readily produce alterations to, variations of, and equivalents to such embodiments. Accordingly, the subject disclosure does not preclude inclusion of such modifications, variations, and/or additions to the present subject matter as would be readily apparent to one of ordinary skill in the art. For instance, features illustrated or described as part of one embodiment or implementation can be used with another embodiment or implementation to yield a still further embodiment. Thus, the present disclosure includes such alterations, variations, and equivalents.

In addition, although FIGS. 3-6 depicts steps performed in a particular order for purposes of illustration and discussion, the methods of the present disclosure are not limited to the particularly illustrated order or arrangement. The various steps illustrated in FIGS. 3-6 can respectively be omitted, rearranged, combined, and/or adapted in various ways without deviating from the scope of the present disclosure.

What is claimed is:

1. A computer-implemented method for monitoring tire tread-life, the method comprising:
receiving, by one or more processors, data associated with one or more tread depth measurements, the one or more tread depth measurements made by a measurement device external to a vehicle, the one or more tread depth measurements descriptive of a tread depth of at least one tread of at least one tire of the vehicle;
associating, by the one or more processors, a respective time value or a distance value with each of the one or more tread depth measurements;
accessing, by the one or more processors, a model that correlates the one or more tread depth measurements to a projected tread depth;
determining, by the one or more processors, an estimated time or an estimated distance at which the projected tread depth is expected to equal or pass a tread depth threshold based at least in part on the model; and
providing, by the one or more processors, the estimated time or the estimated distance to a notification system, the notification system integrated as part of a user computing device.

2. The computer-implemented method of claim 1, further comprising:
receiving, by the one or more processors, sensor data from one or more sensors; and
adjusting, by the one or more processors, the estimated time or the estimated distance based at least in part on the sensor data received from the one or more sensors.

3. The computer-implemented method of claim 2, wherein receiving, by the one or more processors, the sensor data comprises receiving, by the one or more processors, at least one of: lateral acceleration data; longitudinal acceleration data; speed data; weather data; geographic location data; steer angle data; vehicle yaw, pitch, and roll data; and tire inflation pressure data.

4. The computer-implemented method of claim 2, wherein adjusting, by the one or more computing devices, the estimated time based at least in part on the sensor data comprises:
identifying, by the one or more processors, an abnormal change in the sensor data; and
in response to identification of the abnormal change in the sensor data, adjusting, by the one or more processors, the estimated time based at least in part the identified abnormal change in the sensor data.

5. The computer-implemented method of claim 1, wherein determining, by the one or more processors, the estimated time at which the projected tread depth is expected to equal or pass the tread depth threshold comprises:
determining, by the one or more processors, a projection for the projected tread depth based at least in part on one or more tread depth measurements and their associated time values; and
identifying, by the one or more processors, the estimated time or the estimated distance based at least in part on the projection and based at least in part on the tread depth threshold.

6. The computer-implemented method of claim 1, wherein:
receiving, by the one or more processors, data associated with one or more tread depth measurements comprises receiving, by the one or more processors, data associated with a plurality of tread depth measurements respectively for a plurality of tread grooves of the at least one tire;
accessing, by the one or more processors, a model that correlates the one or more tread depth measurements to the projected tread depth comprises accessing, by the one or more processors, the model that correlates the plurality of tread depth measurements respectively to a plurality of projected tread depths respectively for the plurality of tread grooves of the at least one tire; and
determining, by the one or more processors, the estimated time or the estimated distance at which the projected tread depth is expected to equal or pass the tread depth threshold comprises determining, by the one or more computing devices, the estimated time or the estimated distance at which a number of the plurality of projected tread depths respectively for the plurality of tread grooves is expected to equal or pass a respective tread depth threshold for such tread.

7. The computer-implemented method of claim 1, further comprising:
monitoring, by the notification system, a current time; and
providing, by the notification system, an alert to a user when the current time reaches or approaches the estimated time at which the projected tread depth is expected to equal or pass the tread depth threshold.

8. The computer-implemented method of claim 1, wherein the user computing device comprises a smartphone, tablet, or wearable computing device.

9. A system for monitoring tire tread-life, the system comprising one or more computing devices that include at least one processor and at least one non-transitory computer-readable medium that stores instructions that, when executed by the at least one processor, cause the one or more computing devices to:
receive data associated with one or more tread depth measurements, wherein the one or more tread depth measurements were made by a measurement device external to a vehicle, and wherein the one or more tread depth measurements are descriptive of a tread depth of at least one tread of at least one tire of the vehicle;
associate a respective time value with each of the one or more tread depth measurements;
access a model that correlates the one or more tread depth measurements to a projected tread depth;
determine an estimated time at which the projected tread depth is expected to equal or pass a tread depth threshold based at least in part on the model; and
provide the estimated time to a notification system integrated as part of a user computing device.

10. The system of claim 9, wherein execution of the instructions by the at least one processor further causes the one or more computing devices to:
receive sensor data from one or more sensors, wherein the sensor data comprises at least one of: lateral acceleration data; longitudinal acceleration data; speed data; weather data; geographic location data; steer angle data; vehicle yaw, pitch, and roll data; and tire inflation pressure data; and
adjust the estimated time based at least in part on the sensor data received from the one or more sensors integrated into the vehicle.

11. The system of claim 9, wherein to determine the estimated time at which the projected tread depth is expected to equal or pass the tread depth threshold, the one or more computing devices:
determine a projection for the projected tread depth based at least in part on one or more tread depth measurements and their respective time values; and
identify the estimated time based at least in part on the projection and based at least in part on the tread depth threshold.

12. The system of claim 9, wherein execution of the instructions by the at least one processor causes the one or more computing devices to:
receive data associated with a plurality of tread depth measurements respectively for a plurality of tread grooves of the at least one tire;
access the model that correlates the plurality of tread depth measurements respectively to a plurality of projected tread depths respectively for the plurality of tread grooves of the at least one tire; and
determine the estimated time at which any of the plurality of projected tread depths respectively for the plurality of tread grooves is expected to equal or pass a respective tread depth threshold for such tread.

13. The system of claim 9, further comprising:
the notification system, the notification system configured to:
monitor a current time; and
provide an alert to a user when the current time reaches or approaches the estimated time at which the projected tread depth is expected to equal or pass the tread depth threshold.

14. The system of claim 9, wherein the user computing device comprises a smartphone, a tablet, or a wearable computing device.

15. The system of claim 10, wherein the user computing device comprises a smartphone, a tablet, or a wearable computing device, and wherein the one or more sensors are integrated into the smartphone, the tablet, or the wearable computing device.
